(19) United States
(12) Patent Application Publication
(10) Pub. No.: US 2005/0153227 A1
(43) Pub. Date: Jul. 14, 2005

(54) Image forming method

(75) Inventors: Eizo Kurihara, Ebina-shi (JP); Ryosuke Nakanishi, Ebina-shi (JP); Tsukasa Matsuda, Ebina-shi (JP); Tomofumi Tokiyoshi, Koto-ku (JP); Fumihiko Shimizu, Koto-ku (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/022,844

(22) Filed: Dec. 28, 2004

(30) Foreign Application Priority Data
Jan. 9, 2004 (JP) 2004-004461

(51) Int. Cl. G03G 15/20

(52) U.S. Cl. 430/124; 430/47

(57) ABSTRACT

The present invention provides an image forming method including forming an image on a transfer paper for electrophotography by using oilless fixing, in which the transfer paper for electrophotography comprises a thermoplastic foam resin layer on at least one side of a substrate, the thermoplastic foam resin layer containing a thermoplastic resin having a softening point of 50° C. to 120° C. as determined according to JIS K 7234 (Ring and Ball method), and the thermoplastic foam resin layer having an average void size of 0.5 μm to 50 μm on the surface thereof. A difference between a gloss before the fixing and a gloss after the fixing, on a non-image portion, is 10% to 100%.

### CROSS-REFERENCE TO RELATED APPLICATION

This application claims priority under 35 USC 119 from Japanese Patent Application No. 2004-004461, the disclosure of which is incorporated by reference herein.

### BACKGROUND OF THE INVENTION

1. Field of the Invention

The present invention relates to an image forming method for forming an image with evenness and gloss on a transfer paper for electrophotography by an electrophotographic method employed in a color copying machine, a color printer, or the like.

2. Description of the Related Art

Among conventional methods for color image formation using an electrophotographic method, there is a known method that comprises forming electrostatic latent images with individual colors by irradiating color-separated light on a photoreceptor; developing such individual colored electrostatic latent images in order by using color toners such as Y (yellow), M (magenta) and C (cyan) to form individual color toner images; transferring each color toner image onto a transfer material as each color toner image is formed so as to superimpose the color toner images; and hot-melting and fixing the toner images to form a color image.

Another known method includes forming and superimposing individual color toner images together on a photoreceptor in place of a transfer material, transferring all of them at once onto the transfer material, and then hot melting and fixing the transferred images to form a color image. Further, there is a method which comprises superimposing color toner images together by intermediately using a belt or the like positioned between a photo-sensitive material and a transfer material; transferring all of the color toner images at once to the transfer material; and hot-melting and fixing the toner images.

A color toner comprises various dyes or pigments as a colorant which are dissolved together or dispersed in a binder resin and have a particle size of several μm to several tens of μm. As a receptor for such a color toner, a paper substrate such as common paper, general printing paper, or coated paper is employed. On the paper substrate, multiple layers of color toner superimposed together are subjected to a hot-melting and fixing process to form a color image (see, for example, Japanese Patent Application Laid-open (JP-A) No. 63-92965). Since the surface of the obtained color image has, for example, unevenness in the range of 10 to 100 μm, unevenness in gloss of the image may be caused due to such unevenness of the toner layers.

In order to overcome the above problems, a method comprising forming a thermoplastic transparent resin layer on a substrate and embedding a toner image into the transparent resin layer by using a hot-roller fixing apparatus is disclosed. Alternatively, JP-A No. 5-127413 discloses an image forming method which comprises placing toner images on the surface of an image transfer sheet having a transparent resin layer comprising a crosslinked resin which is soluble in tetrahydrofuran and has a glass transition temperature in the range of 40 to 70° C., and embedding the toner into the transparent resin layer by using a belt-type fixing apparatus.

Moreover, JP-A Nos. 5-216322 and 6-11982 disclose an image forming method which comprises placing toner images on the surface of an image transfer sheet coated with thermoplastic resin, and embedding the toner into a transparent resin layer by using a belt-type fixing apparatus.

Transfer sheets capable of providing gloss matching without unevenness in gloss without using the above belt-type fixing apparatus have been disclosed. JP-A No. 10-221877 discloses a transfer sheet (transfer paper for electrophotography) which includes a transparent resin on the surface thereof. An average molecular weight of the resin (Mwa) and that of an adhesive resin for a color toner (Mwb) have a relationship of Mwa−Mwb≧10000. A melting slope angle between the transparent resin and the adhesive resin for the color toner at a fixing temperature of the toner is adjusted to be less than 40°. JP-A No. 11-160905 discloses a transfer paper for electrophotography which has on its surface a transparent resin layer having a number average molecular weight (Mn) in the range of 5000 to 20000 and a glass transition temperature in the range of 30 to 85° C. Further, JP-A No. 2000-275891 discloses a method in which a plasticizer is contained in a thermoplastic resin layer so that a binder or a solid component forming the layer is softened during the fixing process, whereby a toner is embedded into the thermoplastic resin layer.

Techniques described in the above publications commonly relate to a method for fixing a color toner image on a transfer material, which comprises pressing a color toner image by a hot-roller to heat and melt the color toner image, and then embedding the color toner image into a transparent resin layer on the surface of a transfer paper for electrophotography, thereby fixing the image. In such a method, although toner is completely embedded into the thermoplastic resin layer at a low image density region to obtain a high-smoothness and, in turn, to exhibit gloss, the toner cannot be completely embedded into the thermoplastic resin layer at a high image density region. This leads to reduction in gloss due to incompatibility caused by an image height (that is, level difference on the image) of the toner and unevenness generated in an image portion on the surface of the toner, thereby resulting in the image having a wide difference in gloss over the entire image.

In order to solve the above problems such as level difference on the image and a difference in gloss of the overall image, JP-A Nos. 9-171266 and 11-282192 propose a method to overcome the incompatibility caused by level difference on the image and a difference in gloss between an image portion and a non-image portion, by forming a porous coating layer over a support and embedding a toner in voids on the surface of the porous coating layer. However, although the level difference on the image is somewhat improved, the incompatibility still exists since the toner is not completely embedded in the voids on the surface of the porous coating layer. Further, because the difference in gloss is reduced by lowering gloss of the image portion and the non-image portion, the above process cannot be regarded as providing a glossy image.

### SUMMARY OF THE INVENTION

In view of the above circumstances, the present invention provides an image forming method by which images without level difference on the image and having even gloss can be formed on a transfer paper for electrophotography.

As a result of extensive research and study with respect to construction of a transfer paper for electrophotography which can provide a color image without level difference on the image and having even gloss, the present inventors have found certain conditions required to obtain images without level difference on the image and having even gloss, and thus accomplished the present invention on the basis of this finding.

One aspect of the present invention is to provide an image forming method comprising forming a latent image on a latent image holding member, forming a toner image by developing the latent image with a developer, transferring the toner image onto a transfer paper for electrophotography, and fixing the toner image transferred onto the transfer paper for electrophotography by oilless fixing in which the toner image is heat-pressed onto the transfer paper for electrophotography, wherein the transfer paper for electrophotography comprises a thermoplastic foam resin layer on at least one side of a substrate, the thermoplastic foam resin layer containing a thermoplastic resin having a softening point of 50° C. to 120° C. as determined according to JIS K 7234 (Ring and Ball method), and the thermoplastic foam resin layer having an average void size of 0.5 μm to 50 μm on the surface thereof, and a difference between a gloss before the fixing and a gloss after the fixing, on a non-image portion, is 10% to 100%.

### BRIEF DESCRIPTION OF THE DRAWINGS

FIG. 1 is a schematic constructional view illustrating an example of an image forming apparatus preferably employed in an image forming method according to the present invention; and

FIG. 2 is a schematic constructional view illustrating an example of a fixing device that can be used in a fixing process in the image forming method according to the present invention.

### DETAILED DESCRIPTION OF THE INVENTION

An image forming method according to the present invention will be described below.

The image forming method according to the present invention is a method of forming an image on a transfer paper for electrophotography by a conventional electrophotographic method including oilless fixing. Such a transfer paper for electrophotography includes a thermoplastic foam resin layer on at least one side of a substrate, the thermoplastic foam resin layer containing a thermoplastic resin having a softening point in the range of 50° C. to 120° C. as determined according to JIS K 7234 (Ring and Ball method), the disclosure of which is incorporated by reference herein, and the thermoplastic foam resin layer having an average void size of 0.5 μm to 50 μm on the surface thereof. In the transfer paper for electrophotography, a difference between a gloss before the fixing and a gloss after the fixing, on a non-image portion, is 10% to 100%.

Conventionally, in a transfer paper for electrophotography including a thermoplastic resin layer, a color toner image is fixed by heat-pressing the color toner image by using a hot-roller to melt the color toner, thereby embedding the toner in the resin layer on surface of the transfer paper. However, the above method cannot completely embed the color toner into the thermoplastic resin layer in a high-density image region while, in a low-density image region, the toner is embedded in the thermoplastic resin layer to satisfy high-smoothness and exhibit improved gloss. Furthermore, since different gloss is exhibited depending on types of the toner, this may cause incompatibility on the image due to great difference in gloss between a non-image portion and an image portion or even within the same image portion. Particularly, a toner binder of a toner for oilless fixing has a higher storage modulus, compared with a toner which is fixed using oil, and therefore, it is more difficult to embed the toner in the thermoplastic resin layer in a case where a conventional transfer paper such as a glossy paper is used. In addition, there is a method of forming voids on the surface of the resin layer to reduce the difference in gloss and the level difference on the image. However, although the method can somewhat lower the level difference on the image, the method is not sufficient to obtain a favorable glossy image because the difference in gloss is reduced by lowering gloss of the entire image.

Accordingly, the present invention uses a transfer paper having the thermoplastic foam resin layer specified above on at least one side of a substrate in order to eliminate incompatibility due to a level difference between an image portion and a none-image portion after fixing, to smooth out unevenness of an image portion surface, and to form an even glossy image. In this method, the toner firstly enters into voids in the surface of the thermoplastic foam resin layer and then is embedded into the thermoplastic foam resin layer during the fixing process. Subsequently, the resin in the thermoplastic foam resin layer covers the surface of the toner image. As a result, incompatibility due to a level difference on the image and unevenness on the surface of the toner image can be eliminated. Additionally, on the non-image portion, the resin in the thermoplastic foam resin layer softens to fill in the voids, whereby the surface of the thermoplastic foam resin layer is made smooth without unevenness, gloss is improved, and an even, glossy image is formed.

With respect to characteristics of the thermoplastic foam resin layer, the layer is prepared by including a thermoplastic resin having a softening point in the range of 50° C. to 120° C. determined according to JIS K 7234 (Ring and Ball method). If the softening point is in the above range, the toner can be covered with the thermoplastic resin at the image portion while the voids are filled in with the thermoplastic resin at the non-image portion. If the softening point is less than 50° C., softening and melting of the resin in the thermoplastic foam resin layer progresses during the fixing process, resulting in adhesion of the thermoplastic foam resin layer to the fixing roller. Whereas, if the softening point exceeds 120° C., the softening and melting does not occur, and the toner cannot be embedded in the foam resin layer, resulting in deterioration of gloss. The softening point is preferably in the range of 60° C. to 110° C., and more preferably in the range of 70° C. to 100° C.

The thermoplastic foam resin layer has an average void size of 0.5 μm to 50 μm on the surface thereof. When the average void size is in the above range, the toner can be embedded in the voids at the image portion and the voids can be filled in in the non-image portion. If the average void size is less than 0.5 μm, the toner cannot enter into the voids during the transferring process, and therefore, toner in a high-density image region is not embedded in the resin layer even after the fixing process. On the other hand, if the average void size is over 50 μm, although the toner enters into the voids at the time of transfer, the voids cannot be completely filled in during the fixing process and remain as void scar. The average void size is preferably in the range of 1 μm to 40 μm and, more preferably in the range of 2 μm to 30 μm.

The thermoplastic foam resin layer has an improved gloss since the voids are filled in due to softening of the resin on the non-image portion, and has a difference in gloss, that is, a difference in gloss between before and after the fixing process on the non-image portion, of 10% to 100%. In a case where the difference in gloss before and after the fixing process is 10% to 100%, even and functional gloss can be obtained. The difference in gloss before and after the fixing process is preferably 20% to 100%, and more preferably 30% to 100%. The gloss on the non-image portion is also referred to as “white paper gloss”.

In the thermoplastic foam resin layer, it is preferable that a percentage of voids having a void size of 50 μm or more on the surface thereof is in the range of 20% or less based on the total number of voids on the surface of the thermoplastic foam resin layer. With a void size of 50 μm or more, the voids are not completely filled in after the fixing process, and therefore, unevenness remains as void scar on the surface of both the image portion and the non-image portion. Accordingly, if the percentage of voids having a void size of 50 μm or more is more than 20% based on the total numberof voids on the surface of the thermoplastic foam resin layer, this may sometimes cause reduction in gloss. The percentage of voids having a void size of 50 μm or more is more preferably 5% or less, based on the total number of voids, and still more preferably, voids having a void size of 50 μm or more do not exist in the surface of the thermoplastic foam resin layer.

A percentage of the area of the surface of the thermoplastic foam resin layer that is occupied by voids is preferably in the range of 10 to 80%, and more preferably in the range of 20% to 70%. When the percentage of the area is less than 10%, the toner does not sufficiently enter into the voids during the transferring process, sometimes resulting in reduction of gloss due to unevenness generated by the toner on the surface of the thermoplastic foam resin layer. On the other hand, if the percentage of the area is over 80%, it is difficult to form the resin layer and strength of the resin layer is reduced, thereby inhibiting accomplishment of desirable performance for the thermoplastic foam resin layer.

Herein, the voids formed on the surface of the thermoplastic foam resin layer do not necessarily have circular shape. Thus, on the basis of an area within the outline of the void calculated by an image analysis apparatus, the diameter of the void is converted into a circular equivalent diameter. On this basis, the average void size and the percentage of voids having a void size of 50 μm or more can be determined. Further, the average void size, the percentage of voids having a void size of 50 μm or more, and the percentage of the area occupied by voids can be determined by taking photographs of the surface of the foam resin layer by using a scanning electron microscope or an optical microscope; accurately copying pictures of outlines of pores in the surface onto a transparent film by means of a black pen or the like; and then using a drum scanner (trade name: LUZEX III, manufactured by Nireco Corporation) to carry out measurement. The percentage of the area occupied by voids can be calculated by the following formula:
Percentage of area of surface occupied by voids (%)=(Total area of-void portion on surface of resin layer)/(Total surface area of surface of thermoplastic foam resin layer)×100

A coated amount of the thermoplastic foam resin layer (coating amount) is preferably in the range of 2 g/m² to 40 g/m². When the coating amount is less than 2 g/m², the toner cannot be completely embedded in the resin layer during the fixing process, whereby gloss may be reduced. If the coating amount is over 40 g/m², the thickness of the thermoplastic foam resin layer becomes excessively large, whereby the layer may become easily subject to damage. The coating amount of the thermoplastic foam resin layer is more preferably in the range of 5 g/m² to 30 g/m², and still more preferably in the range of 8 g/m² to 20 g/m².

Thermoplastic resin useful for the thermoplastic foam resin layer according to the present invention is not particularly limited but includes conventionally available thermoplastic resins. Such thermoplastic resin includes, for example, ester bond-containing resin; polyurethane resin; polyamide resin such as urea resin; polysulphone resin; polyvinyl chloride resin, polyvinylidene chloride resin, vinyl chloride-vinyl acetate copolymer resin, vinyl chloride-vinyl propionate copolymer resin; polyol resin such as polyvinyl butyral, cellulose resin such as ethyl cellulose resin, cellulose acetate resin, etc.; polycaprolactone resin, styrene-maleic anhydride resin, polyacrylonitrile resin, polyether resin, epoxy resin, phenol resin; polyolefin resin such as polyethylene resin, polypropylene resin, etc., a copolymer resin comprising an olefin such as ethylene or propylene combined with other vinyl monomer, an acrylic resin. Such polymer can be used alone or in combination with two or more of them in a mixture and/or copolymer form.

The thermoplastic foam resin layer may further comprise pigment. The pigment includes, for example, inorganic pigment such as zinc oxide, titanium oxide, calcium carbonate, silicates, clay, talc, mica, calcined clay, aluminum hydroxide, barium sulphate, lithopone, silica, colloidal silica or the like; organic pigment called as plastic pigment in spherical, hollow, star-like, donut-like or flattened form such as polystyrene, polyethylene, polypropylene, epoxy resin, styrene-acrylic copolymer or the like; starch powder, cellulose powder or the like, but is not particularly limited thereto. Such pigment can be used alone or in combination with two or more of them.

The thermoplastic foam resin layer preferably contains a releasing agent. By containing such releasing agent, it can prevent winding of the transfer paper around the fixing roller at the fixing process and easily carry out oilless fixing the toner to the resin layer.

Examples of the releasing agent include waxes, higher fatty acids, higher alcohols, and higher fatty acid amides. The waxes include, but not limited to, vegetable wax such as carnaba wax, rice wax and the like; petroleum based wax such as paraffin, microcrystalline, petrolactam and the like; and synthetic hydrogen carbonate wax such as polyethylene wax.

Examples of the higher fatty acid include stearic acid, oleic acid, palmitic acid, myristic acid, lauric acid. Examples of the higher alcohol include lauryl alcohol, myristyl alcohol, stearyl alcohol, cetyl alcohol, and behenyl alcohol. Examples of the higher fatty acid amid include amide stearate, amide palmitate, methylenebisstearylamide, ethylenebisstearylamide.

The releasing agent is preferably contained in the thermoplastic foam resin layer in an amount of 0.1% by weight to 10% by weight relative to the total amount of the thermoplastic foam resin layer. With the amount less than 0.1% by weight, effect of the releasing agent is not sufficient and the transfer paper may wind around the hot-roller during the fixing process. On the other hand, if the amount exceeds 10% by weight, the amount of the releasing agent seeping out through the surface of the thermoplastic foam resin layer is increased, whereby traces of the releasing agent may remain on the non-image portion or the image portion after the fixing process.

The thermoplastic foam resin layer means a layer having voids on the surface thereof prepared by mechanically stirring a resin coating solution to create fine air bubbles (foam) then coating the solution onto the substrate followed by drying. The voids mean trace of such foam created on the surface of the thermoplastic foam resin layer and are different from fine scratches, cracks, or grooves on the surface of the resin layer.

Methods for generating and dispersing foams in the coating resin solution (foaming method) include using agitation device with blade moving and rotating like a planet, for example, agitation device such as a homomixer generally used for emulsifying, Cawless dissolver; or devices continuously supplying mixture of air and coating solution into a closed system and mechanically stirring the mixture to generate fine air bubbles and to disperse and blend air such as continuous foaming devices available from Gaston Country Dyeing Machine Company in U.S., Stoke Co., Netherlands, etc., but is not particularly limited thereto.

To the coating resin solution, preferably added is foam stabilizer or foaming agent to assist the mechanical stirring ability to obtain desired foam-containing condition and to improve stability of foams in the solution. Specific examples thereof include the higher fatty acid such as stearic acid, palmitic acid, the higher fatty acid salt such as sodium lauryl sulphate, ammonium stearate, ammonium palmitate, and modified higher fatty acid such as alkylalkanolamide, sorbitan fatty ester. These compounds can increase foaming ability of the coating resin solution and effect to improve dispersion stability of foams are desirable for the present invention. Although any of the foam stabilizer and foaming agent is applicable without limitation, the one which inhibits fluidity or deteriorates coating workability of the coating resin solution is preferable to avoid. In addition, amount of the foam stabilizer and the foaming agent to be combined is in the range of 0 to 30 parts by weight in terms of solid component, relative to 100 parts by weight of solid component the above resin or a mixture comprising the above resin and pigment. Preferably, the amount is in the range of 1 to 20 parts by weight and, even if it exceeds 30 parts by weight, it cannot increase desirable effect of adding the above foam stabilizer or the foaming agent.

Methods for applying the thermoplastic foam resin layer onto a substrate include generally known methods, such as Mayer bar method, Clavier roll method, roll method, reverse roll method, blade method, knife method, air-knife method, extrusion method, cast method, etc., but is not particularly limited thereto.

The substrate includes, for example, synthetic paper, woodfree paper, coat paper, art paper, cast-coat paper, film, etc. In case where the paper is used as the substrate, it may be any known pulp including, for example, LBKP (Broad-Leaved Tree Bleached Kraft Pulp), NBKP (Needle-Leaved Tree Breached Kraft Pulp), LBSP (Broad-Leaved Tree Sulfite Pulp), NBSP (Needle-Leaved Tree Sulfite Pulp), non-wooden pulp such as cotton pulp, used paper pulp, GP (gland pulp), TMP (thermomechanical pulp). Examples of method for paper-making include conventional methods such as using a paper machine such as a fourdrinier paper machine; a cylinder paper machine; a Yankee machine, etc.

In case where the coat paper is employed as the substrate, a base paper is not particularly limited but includes a paper substrate, for example, such as acidic paper substrate having about pH 4.5, neutral paper substrate containing alkali filler as its primary component to have from weak acidic to weak basic property in the range of about pH 6 to pH 9, etc. The coat paper as the substrate is a specified coat paper having a coating layer obtained by application of a coating solution including principally adhesive and pigment to at least one side of the coat paper. As for the adhesive used in the coating layer, preferably used is water-soluble and/or water-dispersion type polymer compound including, more particularly, starches such as cationic starch, amphoteric starch, oxidized starch, enzyme-modified starch, thermo-chemical modified starch, esterified starch, etherified starch; cellulose derivatives such as carboxymethyl cellulose, hydroxyethylene cellulose; natural or semi-synthetic polymer compound such as gelatin, casein, soy protein, natural rubber; polydienes such as polyvinyl alcohol, isoprene, neoprene, polybutadiene; polyalkenes such as polybutene, polyisobutene, polypropylene, polyethylene; vinyl based polymers or copolymers such as vinyl halide, vinyl acetate, styrene, (meth)acrylic acid, (meth)acrylic ester, (meth)acrylamide, methylvinylether; synthetic rubber latex such as styrene-butadiene, methylmethacrylate-butadiene; synthetic polymer compounds such as polyurethane resin, polyester resin, polyamide resin, olefin-maleic anhydride resin, melamine resin, etc. One or two or more among the above compounds is (are) preferably employed depending on desirable quality for the transfer paper for electrophotography.

The content of the adhesive contained in the coating solution is preferably in the range of 5 to 50 parts by weight relative to 100 parts by weight of the pigment. If the content is less than 5 parts by weight, surface of the substrate is affected by the coating resin solution when a resin layer is applied onto the coating layer obtained, thereby resulting in failure of excellent white paper gloss. On the contrary, with more than 50 parts by weight of the adhesive, foams may be generated during the coating process of the pigment coating layer and, in turn, produce uneven coated surface, thereby resulting in failure of excellent white paper gloss.

The pigment includes, for example, mineral pigment such as heavy calcium carbonate, light calcium carbonate, kaolin, calcined kaolin, constructional kaolin, delaminated kaolin, talc, calcium sulphate, barium sulphate, titanium dioxide, zinc oxide, alumina, magnesium carbonate, magnesium oxide, silica, magnesium alumino-silicate, calcium silicate particulate, magnesium silicate particulate, light calcium carbonate particulate, white carbon, bentonite, zeolite, sericite, smectite; organic pigment such as polystyrene resin, styrene-acrylic copolymer resin, urea resin, melamine resin, acryl resin, vinylidene chloride resin, benzoguanamine resin; and microporous hollow particles or penetration type organic pigment, etc. One or two or more among such pigment is (are) preferably employed.

The coating solution for the pigment coating layer may further contain various auxiliaries such as, for example, surfactant, pH regulator, viscosity regulator, softening agent, glossing agent, dispersant, flow modifying agent, anti-conductive agent, stabilizer, anti-static agent, cross-linking agent, antioxidant, sizing agent, optical brightening agent, colorant, UV absorbing agent, anti-foaming agent, anti-hydrating agent, plasticizer, lubricant, preservative, aroma, etc., if required.

With respect to amount of the pigment coating layer, the amount is selected based on purpose of the transfer paper and, generally, required to completely cover unevenness on the surface of the substrate. Preferably, the amount is 8 to 40 g/m² in terms of dry weight. Process for forming the coating layer includes using typically known coating devices, for example, blade coater, air-knife coater, roller coater, reverse roller coater, bar coater, curtain coater, die coater, gravure coater, Champlex coater, brush coater, two-roller- or metering blade-type size press coater, bill blade coater, shorted dwell coater, gate roller coater, etc.

Such pigment coating layer may be formed on either side or both sides of the paper substrate, and may have a multi-layers structure which has at least one intermediate layer or two or more intermediate layers if required. In case where the pigment coating layer is formed on both sides or has the multi-layers structure, amount of the coating solution or amount of the pigment coating solution needs not be same for each of the multiple layers but may be adjusted depending on quality level desired by users. Alternatively, if the pigment coating layer is formed on one side of the paper substrate, it can lead to obtain curl generation prevention ability, printing suitability, and paper input/output suitability by forming a synthetic resin layer, a coating layer containing adhesive, pigment, and/or an anti-static layer or the like to the other side (rear side) of the paper substrate. Moreover, by carrying out different process, for example, post-treatments such as adhesion, magnetizing, flame-retardant, heat-resistant, water-proof, oil-proof or sliding-preventing treatments, etc. to the rear side of the paper, various useful abilities can be preferably applied to the paper.

The substrate having the pigment coating layer is under any finishing treatment such as common drying or surface-treatment process to regulate water content to 3 to 10% by weight and, more preferably, 4 to 8% by weight.

In order to endow smoothness to the substrate, common flattening treatment apparatus such as typical super calendar, gloss calendar, soft calendar, etc. may be used. Alternatively, by means of on-machine and/or off-machine, it can also provide improved smoothness to the substrate. Types of processing device, numbers of pressing nipper, temperature raising, etc. are controlled based on the common smoothing treatment apparatus.

For the transfer paper for electrophotography according to the present invention, it is obtainable to produce favorable image with a foam-containing coating solution under a condition of processing and drying the solution. It is more effective to enhance smoothness of surface of the transfer paper with a specified super calendar appropriately comprising metal roller, resin roller, and/or a combination of the metal roller and the cotton roller. Also, after completely conducting the coating process, the sheet under a semi-drying or drying condition contacts a cast drum carrying out mirror-side finishing treatment under a condition of raising temperature or not to further improve surface evenness of the porous coating layer.

However, if the smoothing treatment is conducted under excessive pressure, it may cause several adverse effects such that it damages resin walls surrounding foams in the thermoplastic foam resin layer; compacts the coating layer to lead reduction of insulating ability or cushion effect; breaks pores in the surface of the thermoplastic foam resin layer to loss excellent transferring ability of the thermoplastic foam resin layer. Therefore, it should sufficiently take care of the condition for the smoothing and finishing treatment described above.

The transfer paper for electrophotography is preferably regulated for its composition to have a surface electric resistance of 8.0×10⁸ Ω or more at a temperature of 28° C. and 85% relative humidity.

The image forming method will be described in more detail.

The image forming method according to the present invention is the one using conventional electrophotographic method and utilizes the transfer paper for electrophotography described above as an object to be transferred (transfer material). The image formation method is not particularly limited but, preferably includes:
that is, forming a latent image on a latent image holding member, forming a toner image by developing the latent image with a developer, transferring the toner image onto the transfer material, and fixing the toner image transferred onto the transfer material by heat-pressing. The fixing process is carried out by an oilless fixing process.

Such an oilless fixing process means a method for fixing without containing any releasing agent such as oil on surface of a member to be fixed during the fixing process. Generally, it employs a common fixing device omitted with means supplying the releasing agent to the surface of the fixed member. The present image forming method may further include additional process other than the four processes described, if required.

The oilless fixing process is preferably used since the obtained image surface has reduced roughness and is easy to write on the image surface because oil is not used.

As resin component of the toner, mainly used is polyester resin or styrene-acrylic resin. The toner formation method comprises any one selected from conventionally known processes such as breaking, polymerization, etc.

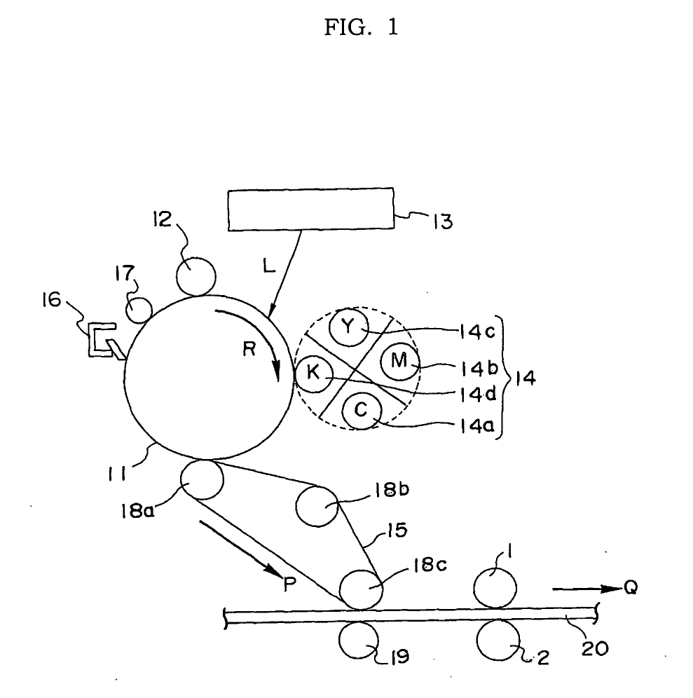

Next, the present image forming method will be illustrated with reference to the accompanying drawing. FIG. 1 is a schematically constructional view illustrating an example of apparatus for image formation preferably employed in the present image formation method.

FIG. 1 shows a hot-fixing roller 1, a pressing roller 2, a photoreceptor (latent image holding member) 11, a roller type charging device 12, a light exposure device 13, a developing device loaded with a developer (cyan) 14a, a developing device loaded with a developer (magenta) 14b, a developing device loaded with a developer (yellow) 14c, a developing device loaded with a developer (black) 14d, a developing apparatus 14, an intermediate transfer body 15, a cleaner 16, an optical electric charge removal device 17, spindle rollers 18a, 18b and 18c, a transfer roller 19 and a transfer material (the transfer paper for electrophotogrphy of the present invention) 20.

The apparatus shown in FIG. 1 comprises, in the clockwise direction, the roller type charging device 12, the light exposure device 13, the developing apparatus 14 incorporating developing devices 14a to 14d respectively loaded with cyan, magenta, yellow and black developers, the intermediate transfer body 15, the cleaner 16 and the optical electric charge removal device 17 arranged in this order around the photoreceptor 11 which is rotatable in the arrow R direction.

The intermediate transfer body 15 is suspended in a tensioned condition by the spindle rollers 18a, 18b and 18c arranged at its inner circumferential surface and can rotate in the arrow P direction. The spindle roller 18a is pressed and contacted through the intermediate transfer body 15 to the photoreceptor 11. The spindle roller 18c is pressed and contacted through the intermediate transfer body 15 to the transfer roller 19.

The transfer material 20 can be inserted in the arrow Q direction into a contact portion between an outer circumferential surface (hereinafter, referred to as “circumference”) of the intermediate transfer body 15 and the transfer roller 19. A hot roller device including the hot-fixing roller 1 and the pressing roller 2 pressed and contacted thereto is arranged on the arrow Q direction side of the contact portion between the outer circumference of the intermediate transfer body 15 and the transfer roller 19. The transfer material 20 which has passed through the contact portion between the circumference of the intermediate transfer body 15 and the transfer roller 19, can be inserted into a contact portion between the hot-fixing roller 1 and the pressing roller 2 in the arrow Q direction.

Image formation using the present image formation apparatus represented in FIG. 1 is carried out as follows. Firstly, the photoreceptor 11 rotating in the arrow R direction is charged using the roller type charging device 12. Light L is emitted from the light exposure device 13 to the charged portion on the photoreceptor 11 on the basis of image information corresponding to the respective colors of cyan, magenta, yellow so that the surface of the photoreceptor 11 is exposed to the light L and a latent image is formed. The latent image formed on the surface of the photoreceptor 11 is developed in the developing devices 14a, 14b, 14c, 14d incorporated into the developing apparatus 14 to form a toner image for each color. The developed toner images are transferred on the circumference of the belt-shaped intermediate transfer body 15.

Each of the toner images transferred on the circumference of the intermediate transfer body 15 moves to a position between the spindle roller 18c and the transfer roller 19, which is pressed and contacted thereto via the intermediate transfer body 15, accompanying progression of the intermediate transfer body 15 in the arrow P direction. When the toner images on the circumference of the intermediate transfer body 15 pass the contact portion (nip part) of the spindle roller 18c and the transfer roller 19 pressed and contacted thereto through the intermediate transfer body 15, the toner images are transferred to the transfer material 20 inserted into the nip part in the arrow Q direction. When the transfer material 20 passes through the contact portion between the hot-fixing roller 1 and the pressing roller 2 in the arrow Q direction, the toner images transferred on the transfer material 20 are fixed on the transfer material 20 to form an image.

After transferring the toner images onto the circumference of the intermediate transfer body 15, the photoreceptor 11 rotates in the arrow R direction to remove the toner remained on the photoreceptor 11 using the cleaner 16, and remove residual charge remained on the photoreceptor 11 using the optical electric charge removal device 17 to prepare further image formation.

Examples of the fixing apparatus used in the image forming method according to the present invention include a contact type hot-fixing apparatus, for example, a hot roller fixing apparatus including a hot-fixing roller having an elastic rubber layer on the core grid and optionally a surface layer of fixing member and a pressing roller having another elastic rubber layer on the core grid and optionally another surface layer of fixing member and hot fixing apparatuses. A combination of such rollers is replaced by a combination of a roller and a belt or a combination of a belt and a belt, either of the two members of which has heating and/or pressing function, may be used.

The substrate (core) of the fixing member is prepared selecting desirable material having excellent heat-resistance, strong tolerance against modification and high thermal conductivity. For the roller type fixing apparatus, exemplified is aluminum, iron or copper. In case of the belt type fixing apparatus, exemplified is polyimide film, stainless belt, etc. On surface of the substrate for the roller type fixing apparatus, formed is an elastic rubber layer comprising commonly silicone rubber, fluorine rubber, etc.

The above fixing member may further contain varied additives depending on purpose thereof and, for example, carbon black or metallic oxides, ceramic particles such as SiC in order to improve abrasion resistance property and control the resistance.

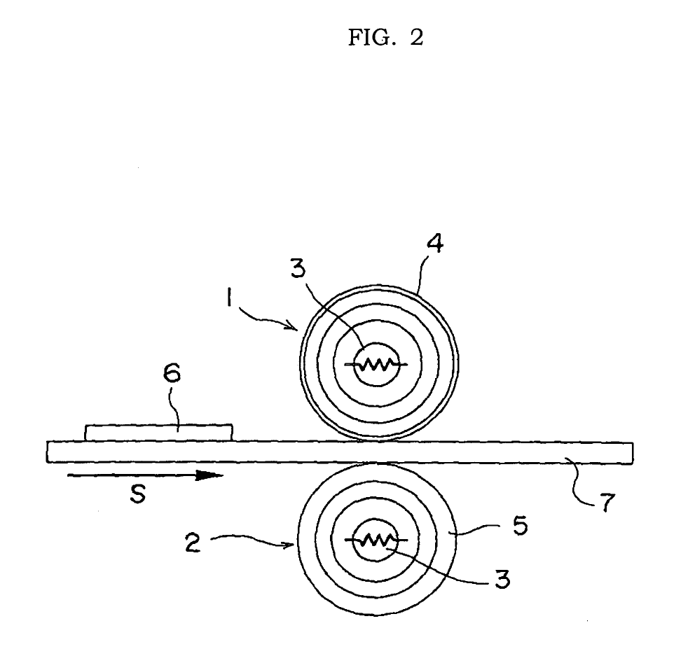

Next, the fixing process according to the present invention will be illustrated with reference to drawings. FIG. 2 is a schematic constructional view illustrating an example of a fixing device that can be used in a fixing process of the image forming method according to the present invention. FIG. 2 shows the hot-fixing roller 1, the pressing roller 2, a heating source 3, a surface layer 4 of the fixing member, a resilient layer 5, the toner image 6, and the transfer material (the transfer paper for electrophotography of the present invention) 7. The reference numerals 1 and 2 in FIG. 2 represent components having basically the same functions as those in FIG. 1.

The fixing apparatus illustrated in FIG. 2 is an apparatus having the fixing member in a roller form, and the basic structure thereof includes the hot-fixing roller 1 and the pressing roller 2 opposite to the roller 1. The hot-fixing roller 1 includes the heating source 3 at the inside thereof and at least one layer to enclose the heating source 3, such as the resilient layer 5. A surface layer 4 of the fixing member, which is located at the outmost periphery, is formed on the circumference of the resilient layer 5.

The pressing roller 2 include the heating source 3 at the inside thereof and at least one layer to enclose the heating source 3, such as the resilient layer 5 located at the outmost circumference. A configuration in which the heating source 3 is not provided inside the pressing roller 2 may also be used. Additionally, the heating source 3 is controlled by an unillustrated temperature control device so as to obtain a desired heating temperature.

The transfer material 7 having the toner images 6 formed on a side thereof contacting the hot-fixing roller 1 can be inserted into a contact portion between the hot-fixing roller 1 and the pressing roller 2 in an arrow S direction. When the transfer material 7 passes through the contact portion, the toner image 6 is fixed by heat-pressing to form an image on the surface of the transfer material 7.

Around the hot-fixing roller 1, optionally arranged are other members such as cleaning member removing toner remained on the surface of the hot-fixing roller 1, nail (finger) releasing the transfer material 7 out of the surface of the hot-fixing roller 1.

The hot-fixing roller 1 and the pressing roller 2 preferably include the resilient layer 5 in a single layer or a laminate form. The resilient layer 5 has preferably a thickness in the range of 0.1 to 3 mm and, more preferably, 0.5 to 2 mm. The resilient layer 5 is prepared from heat-resistant rubber such as silicone rubber and fluororubber, having preferably a rubber hardness of 60 or less. If the fixing member has the resilient layer 5, it is advantageous because the fixing member is modified corresponding to uneven portions in the toner image 6 on the transfer material 7 to improve an smoothness of image surface after the fixing process. In case where the thickness of the resilient layer 5 exceeds 3 mm, since thermal capacity of the fixing member increases and it takes long time to heat the fixing member up to desired temperature, in addition to, may require more energy to be consumed. On the contrary, if the thickness is less than 0.1 mm, the modification of the fixing member cannot follow the unevenness on the toner image. As a result, it may cause generation of unevenness gloss and distortion of the resilient layer effective to releasing of the layer may not be obtained.

### EXAMPLES

The following examples and comparative examples further illustrate the present invention, but should not be construed to limit the present invention. In the following description, the terms “parts” and “%” mean “parts by weight” and “% by weight”, respectively unless otherwise specified.

### Example 1

To 157 g/m² commercial woodfree paper A (OK PRINCE, manufactured by Oji Paper Co., Ltd.), a foam-containing coating solution with the following composition is applied using an applicator bar immediately after the preparation to form desirable thermoplastic foam resin layer, thereby, resulting in obtaining a transfer paper for electorphotograhy having a basis weight of 167.3 g/m².

(Preparation of Foam-Containing Coating Solution)

Thermoplastic resin A: styrene acrylic acid resin (JONCRYL 52, Manufactured by JOHNSON POLYMER CORPORATION) (105° C. softening point by Ring and Ball method) 100 parts by weight.

Foam stabilizer: higher fatty acid type (DC 100A, San Nopco Limited) 10 parts by weight.

Thickener: carboxymethyl cellulose (AG gum SG, Dai-ichi Kogyo Seiyaku Co., Ltd.) 5 parts by weight.

Releasing agent: polyether-modified silicone oil (KF-354L, Sinetsu Chemical Co., Ltd.) 5 parts by weight.

Foaming condition: The foam-containing coating solution is blended with air at 1000 rpm using a continuous foaming device (TURBOWHIP TW-70, manufactured by AICOHSHA MFG. CO., LTD.) then stirred to generate foams in order to increase the foaming volume rate by 3 times.

### Example 2

The process according to Example 1 is repeated except for replacing the paper A with 157 g/m² commercial woodfree paper B (OK TOP COAT N, manufactured by Oji Paper Co., Ltd.), thereby, resulting in obtaining a transfer paper for electrophotography having a basis weight of 167.2 g/m².

### Example 3

The process according to Example 2 is repeated except for using the coating solution with the following composition, thereby, resulting in obtaining a transfer paper for electrophotography having a basis weight of 167.8 g/m²

(Preparation of Foam-Containing Coating Solution)

Thermoplastic resin B: ethylene acrylic resin (ZAIKTHENE AC, manufactured by Sumitomo Seika Chemicals Company Limited) (60° C. softening point by Ring and Ball method) 100 parts by weight.

Foam stabilizer: higher fatty acid system (DC 100A, manufactured by San Nopco Limited) 10 parts by weight.

Thickener: carboxymethyl cellulose (AG gum SG, manufactured by Dai-ichi Kogyo Seiyaku Co., Ltd.) 5 parts by weight.

Releasing agent: polyether-modified silicone oil (KF-354L, manufactured by Sinetsu Chemical Co., Ltd.) 5 parts by weight.

Foaming condition: The foam-containing coating solution is blended with air at 1000 rpm using a continuous foaming device (TURBOWHIP TW-70, manufactured by AICOHSHA MFG. CO., LTD.) then stirred to generate foams in order to increase the foaming volume rate by 3 times.

### Example 4

The process according to Example 2 is repeated except for changing the foaming condition to modify area rate of void on surface of the thermoplastic foam resin layer into 45.2% and, thereby, resulting in obtaining a transfer paper for electrophotography having a basis weight of 166.3 g/m².

### Example 5

The process according to Example 4 is repeated except for changing amount of the coating solution of the thermoplastic foam resin layer into 5 g/m², thereby, resulting in obtaining a transfer paper for electrophotography having a basis weight of 162.1 g/m².

### Example 6

The process according to Example 4 is repeated except for changing amount of the coating solution of the thermoplastic foam resin layer into 25 g/m², thereby, resulting in obtaining a transfer paper for electrophotography having a basis weight of 183.5 g/m².

### Example 7

The process according to Example 2 is repeated except for changing the foaming condition to alter area rate of the void, average void size of the thermoplastic foam resin layer into 62.1% and 16.8 μm, respectively, and resulting in obtaining a transfer paper for electrophotography having a basis weight of 166.9 g/m².

### Example 8

The process according to Example 5 is repeated except for changing the foaming condition to alter average void size of the thermoplastic foam resin layer into 37.5 μm and resulting in obtaining a transfer paper for electrophotography having a basis weight of 166.4 g/m².

### Comparative Example 1

To 157 g/m² commercial coat paper (OK TOP COAT N, manufactured by Oji Paper Co., Ltd.), the coating solution which is prepared as in Example 1 without the foaming process, is applied using an applicator bar to form desirable thermoplastic foam resin layer, thereby, resulting in obtaining a transfer paper for electrophotography having a basis weight of 167.4 g/m².

### Comparative Example 2

The process according to Example 5 is repeated except for changing the foaming condition to alter an average void size of the thermoplastic foam resin layer into 58.4 μm and resulting in obtaining a transfer paper for electrophotography having a basis weight of 169.4 g/m².

### Comparative Example 3

The process according to Example 2 is repeated except for using the foam-containing coating solution with the following composition, hereby, resulting in obtaining a transfer paper for electrophotography having a basis weight of 167.7 g/m² Of.

(Preparation of Foam-Containing Coating Solution)

Thermoplastic resin C: ethylene-vinyl acetate copolymer resin (CHEMIPEARL V200, manufactured by Mitsui Chemicals, Inc.) (40° C. softening point by Ring and Ball method) 100 parts by weight.

Foam stabilizer: higher fatty acid type (DC 100A, manufactured by San Nopco Limited) 10 parts by weight.

Thickener: carboxymethyl cellulose (AG gum SG, manufactured by Dai-ichi Kogyo Seiyaku Co., Ltd.) 5 parts by weight.

Releasing agent: polyether-modified silicone oil (KF-354L, manufactured by Sinetsu Chemical Co., Ltd.) 5 parts by weight.

Foaming condition: The foam-containing coating solution is blended with air at 1000 rpm using a continuous foaming device (TURBOWHIP TW-70, manufactured by AICOHSHA MFG. CO., LTD.) then stirred to generate foams in order to increase the foaming volume rate by 3 times.

### Comparative Example 4

The process according to Example 2 is repeated except for using the foam-containing coating solution with the following composition, hereby, resulting in obtaining a transfer paper for electrophotography having a basis weight of 166.8 g/m².

(Preparation of Foam-Containing Coating Solution)

Thermoplastic resin D: styrene acrylic acid resin (JONCRYL 57, manufactured by JOHNSON POLYMER CORPORATION) (127° C. softening point by Ring and Ball method) 100 parts by weight.

Foam stabilizer: higher fatty acid type (DC 100A, manufactured by San Nopco Limited) 10 parts by weight.

Thickener: carboxymethyl cellulose (AG gum SG, manufactured by Dai-ichi Kogyo Seiyaku Co., Ltd.) 5 parts by weight.

Releasing agent: polyether-modified silicone oil (KF-354L, manufactured by Sinetsu Chemical Co., Ltd.) 5 parts by weight.

Foaming condition: The foam-containing coating solution was blended with air at 1000 rpm using a continuous foaming device (TURBOWHIP TW-70, manufactured by AICOHSHA MFG. CO., LTD.) then stirred to generate foams in order to increase the foaming volume rate by 3 times.

### Comparative Example 5

The process according to Example 4 is repeated except for changing amount of the coating solution of the thermoplastic foam resin layer into 2 g/m², thereby, resulting in obtaining a transfer paper for electrophotography having a basis weight of 159.4 g/m².

### Comparative Example 6

The process according to Example 4 is repeated except for changing amount of the coating solution of the thermoplastic foam resin layer into 40 g/m², thereby, resulting in obtaining a transfer paper for electrophotography having a basis weight of 198.6 g/m².

(Quality Evaluation Method)

Evaluated results for all of the transfer paper for electrophotography obtained from the above examples and comparative examples are represented in Tables 1 and 2. The evaluation results are obtained by the following measurements.

(Image Formation)

The transfer paper for electrophotography obtained is subjected to formation of image by using an image forming apparatus having the same structure as FIG. 1, DOCUCENTRECOlOR 500 (manufactured by Fuji Xerox Co., Ltd., Equipped with oilless fixing device same as illustrated in FIG. 2), and to evaluation of the obtained image. Second mode for the thick paper of DOCUCENTRECOLOR 500 is used as the fixing condition, and the transfer paper is output.

(Basis Weight Measurement)

A basis weight of the transfer paper is measured by a method described in JIS P 8124, the disclosure of which is incorporated by reference herein.

(Measurement of Softening Point by Ring and Ball Method)

A softening point is measured by a method described in JIS K7234, the disclosure of which is incorporated by reference herein.

(Measurement of Void)

For voids in surface of the thermoplastic foam resin layer, an average void size, a percentage of voids having a void size of 50 μm or more, a percentage of the area of the surface occupied by voids are determined by taking photographs of the surface of the thermoplastic foam resin layer by using a scanning electron microscope or an optical microscope; accurately copying pictures of outlines of pores in the surface onto a transparent film by means of a black pen or the like; and then using a drum scanner (trade name: “LUZEX III”, manufactured by Nireco Corporation) to carry out measurement.

Herein, the voids formed on the surface of the thermoplastic foam resin layer do not necessarily have circular shape. Therefore, on the basis of an area within the outline of the void calculated by an image analysis apparatus, the diameter of the void is converted into a circular equivalent diameter. On this basis, the average void size and the percentage of voids having a void size of 50 μm or more is determined. The percentage of the area of the surface occupied by voids is calculated by the following formula:
Percentage of area of surface occupied by voids (%)=(Total area of void portion on surface of resin layer)/(Total surface area of surface of thermoplastic foam resin layer)×100

(Measurement of Gloss)

According to a method described in JIS Z 8741, the disclosure of which is incorporated by reference herein, and by using the gloss measurement device (Type GM-26D, manufactured by Murakami Color Research Laboratory), determined are the glossiness under a condition of 60° between incidence angle and light-receipt angle for the image portion and the non-image portion before and after the fixing process and the difference in gloss before and after the fixing process.

(Evaluation of Evenness in Gloss in the Image Portion)

Firstly, a color chart (S7) image sample is prepared according to high-accuracy color digital standard image data (in conformity with ISO/JIS-SCID JIS X 9201-1995, published by Japanese Standards Association, the disclosure of which is incorporated by reference herein). For the prepared sample, Δ gloss of the image portion is confirmed, in which A gross represents an equation like as Δ gloss (%)=maximum gloss portion (%)−minimum gloss portion (%). Second mode for the thick paper of DOCUCENTRECOLOR 500 is used as the fixing condition, and the transfer paper is output.

(Evaluation of Level Difference on the Image)

Difference of height at outline between the non-image portion and the image portion defined as level difference on the image is determined. As an evaluation means, a super depth shape microscope (VK-8000, manufactured by Keyence Corporation) is employed to determine level difference between the image portion 100% fixed with tertiary color and the non-image portion. Values in Tables are an average of values measured in five locations.

TABLE 1

| | Ex.1 | Ex.2 | Ex.3 | Ex.4 | Ex.5 | Ex.6 | Ex.7 | Ex.8 |
|---|---|---|---|---|---|---|---|---|
| Substrate | Woodfree | Coat | Coat | Coat | Coat | Coat | Coat | Coat |
| | paper A | paper B | paper B | paper B | paper B | paper B | paper B | paper B |
| Basis weight (g/m²) | 167.3 | 167.2 | 167.8 | 166.3 | 162.1 | 183.5 | 166.9 | 166.4 |
| Thermoplastic foam resin | Resin A | Resin A | Resin B | Resin A | Resin A | Resin A | Resin A | Resin A |
| Coating amount (g/m²) | 10 | 10 | 10 | 10 | 5 | 25 | 10 | 10 |
| Softening point by Ring and Ball method (° C.) | 105 | 105 | 60 | 105 | 105 | 105 | 105 | 105 |
| Average void size (μm) | 4.6 | 4.8 | 4.6 | 5 | 5.3 | 5.4 | 16.8 | 37.5 |
| Percentage of the number of voids having a void size of | 0.8 | 1.1 | 1.2 | 4.2 | 4.4 | 4.1 | 13.5 | 18.4 |
| 50 μm or more based on the total number of voids (%) | | | | | | | | |
| Percentage of the area of the surface of the resin layer | 26.3 | 25.8 | 24.8 | 45.2 | 46.3 | 43.5 | 62.1 | 66.3 |
| that is occupied by voids (%) | | | | | | | | |
| Difference in gloss on white paper portion before and | 15 | 24 | 66 | 59 | 56 | 51 | 42 | 37 |
| after the fixing (60° gloss %) | | | | | | | | |
| Maximum glossiness (60° gloss %) | 55 | 66 | 78 | 72 | 66 | 64 | 56 | 50 |
| Δ gloss (%) | 7 | 9 | 5 | 7 | 8 | 9 | 4 | 8 |
| Level difference between the image portion 100% fixed | 2.0 | 1.5 | 1.0 | 0.5 | 1.0 | 0.5 | 0.1 | 0.1 |
| with a tertiary color and the non-image portion (μm) | | | | | | | | |

TABLE 2

| | Comp. | Comp. | Comp. | Comp. | Comp. | Comp. |
|---|---|---|---|---|---|---|
| | Ex.1 | Ex.2 | Ex.3 | Ex.4 | Ex.5 | Ex.6 |
| Substrate | Coat | Coat | Coat | Coat | Coat | Coat |
| | paper B | paper B | paper B | paper B | paper B | paper B |
| Basis weight (g/m²) | 167.4 | 169.4 | 167.7 | 166.8 | 159.4 | 198.6 |
| Thermoplastic foam resin | Resin A | Resin A | Resin C | Resin D | Resin A | Resin A |
| Coating amount (g/m²) | 10 | 10 | 10 | 10 | 2 | 40 |
| Softening point by Ring and Ball | 105 | 105 | 40 | 127 | 105 | 105 |
| method (° C.) | | | | | | |
| Average void size (μm) | 0 | 58.4 | 15.5 | 17.6 | 4.8 | 5.2 |
| Percentage of the number of voids | 0 | 32.5 | 11.5 | 13.8 | 4.3 | 4.5 |
| having a void size of 50 μm or more | | | | | | |
| based on the total number of voids | | | | | | |
| (%) | | | | | | |
| Percentage of the area of the | 0 | 69.7 | 50.4 | 48.3 | 48.1 | 50.9 |
| surface of the resin layer that is | | | | | | |
| occupied by voids (%) | | | | | | |
| Difference in gloss on white paper | 4 | 5 | No | 3 | 8 | 3 |
| portion before and after the fixing | | | determin- | | | |
| (60 ° gloss %) | | | able at | | | |
| Maximum glossiness (60° gloss %) | 72 | 35 | winding | 15 | 23 | 15 |
| Δ gloss (%) | 55 | 19 | around | 11 | 13 | 15 |
| Level difference between the image | 14 | 2 | the fixing | 15 | 12 | 8 |
| portion 100% fixed with a tertiary | | | roll | | | |
| color and the non-image portion | | | | | | |
| (μm) | | | | | | |

As clearly known in Tables 1 and 2, the image forming method according to the present invention is effective in producing color images having even gloss without level difference on the image and practically useful.

Therefore, it is possible to accomplish formation of an even, glossy image without level difference on transfer paper for electrophotography by the image formation method of the present invention.

1. An image forming method comprising:
forming a latent image on a latent image holding member;
forming a toner image by developing the latent image with a developer;
transferring the toner image onto a transfer paper for electrophotography; and
fixing the toner image transferred onto the transfer paper for electrophotography by oilless fixing in which the toner image is heat-pressed onto the transfer paper for electrophotography,
wherein the transfer paper for electrophotography comprises a thermoplastic foam resin layer on at least one side of a substrate, the thermoplastic foam resin layer containing a thermoplastic resin having a softening point of 50° C. to 120° C. as determined according to JIS K 7234 (Ring and Ball method), and the thermoplastic foam resin layer having an average void size of 0.5 μm to 50 μm on the surface thereof, and a difference between a gloss before the fixing and a gloss after the fixing, on a non-image portion, is 10% to 100%.

2. The image forming method according to claim 1, wherein, in the thermoplastic foam resin layer, a percentage of voids having a void size of 50 μm or more on the surface thereof is in the range of 20% or less based on the total number of voids on the surface of the thermoplastic foam resin layer.

3. The image forming method according to claim 1, wherein a percentage of the area of the surface of the thermoplastic foam resin layer that is occupied by voids is in the range of 10% to 80%.

4. The image forming method according to claim 1, wherein the coating amount of the thermoplastic foam resin layer is in the range of 2 g/m² to 40 g/m².

5. The image forming method according to claim 1, wherein the thermoplastic foam resin layer contains a releasing agent.

6. The image forming method according to claim 5, wherein the thermoplastic foam resin layer contains the releasing agent in an amount of 0.1% to 10% by weight relative to the total amount of the thermoplastic foam resin layer.

7. The image forming method according to claim 1, wherein the softening point of the thermoplastic resin is 60° C. to 110° C.

8. The image forming method according to claim 1, wherein the average void size is 1 μm to 40 μm.

9. The image forming method according to claim 1, wherein the difference between a gloss before the fixing and a gloss after the fixing, on a non-image portion, is 20% to 100%.

10. The image forming method according to claim 1, wherein a percentage of the area of the surface of the thermoplastic foam resin layer that is occupied by voids is in the range of 20% to 70%.

11. The image forming method according to claim 1, wherein the coating amount of the thermoplastic foam resin layer is in the range of 5 g/m² to 30 g/m².

12. The image forming method according to claim 1, wherein the thermoplastic foam resin layer contains a pigment.

13. The image forming method according to claim 5, wherein the transfer paper for electrophotography has a surface electric resistance of 8.0×10⁸ Ω or more at a temperature of 28° C. and 85% relative humidity.
